(19) United States
(12) Patent Application Publication
(10) Pub. No.: US 2018/0195407 A1
(43) Pub. Date: Jul. 12, 2018

(54) AIRCRAFT ENGINE HAVING SEAL ASSEMBLY DEFINING AN ELECTRICALLY CONDUCTIVE PATH

(71) Applicant: PRATT & WHITNEY CANADA CORP., Longueuil (CA)

(72) Inventors: Richard KUDRNA, Carignan (CA); Mélanie BRILLANT, Saint-Amable (CA)

(21) Appl. No.: 15/404,571

(22) Filed: Jan. 12, 2017

(51) Int. Cl. F01D 25/00; F02K 3/06; F02C 7/28; F01D 25/24; F01D 11/00

(52) U.S. Cl. CPC F01D 25/005; F02K 3/06; F02C 7/28; B64D 27/10; F01D 11/003; F05D 2240/55; F01D 25/24

(57) ABSTRACT

The aircraft engine can have an engine casing housing the engine, the engine casing having a shaft aperture; a shaft rotatably mounted to the engine casing, the shaft protruding from the engine casing through the shaft aperture; and a seal assembly extending between the engine casing and the shaft adjacent the shaft aperture, the seal assembly defining an electrically conductive path between the engine casing and the shaft.

### TECHNICAL FIELD

The application related generally to aircraft engines and, more particularly, to electrical charge dissipation in aircraft engines.

### BACKGROUND OF THE ART

Some aircraft engines involve the rotation of a shaft which protrudes from an engine casing to drive a propeller, helicopter blades, an electric generator or the like. Rotation of the shaft may be facilitated by one or more bearing assemblies, which interface between the rotating shaft and stationary engine components such as an engine casing.

The shaft can be at a different electrical potential than non-rotating engine components during operation. Indeed, the bearing assemblies, which typically are the main mechanical interface between the rotary and non-rotary engine components, are generally covered by an oil film, which is electrically insulating. If the electrical potential difference reaches a certain threshold, dielectric breakdown can occur in the oil film, and an electrical current can suddenly pass through a bearing assembly to the non-rotating engine components, causing electrical discharge damage to the bearing assembly.

Several techniques have been presented in the past to address this problem. While satisfactory to a certain degree, there remains room for improvement.

### SUMMARY

In another broad aspect, there is provided an aircraft engine comprising: an engine casing housing the engine, the engine casing having a shaft aperture; a shaft rotatably mounted to the engine casing, the shaft protruding from the engine casing through the shaft aperture; and a seal assembly extending between the engine casing and the shaft adjacent the shaft aperture, the seal assembly defining an electrically conductive path between the engine casing and the shaft.

In a further aspect, there is provided a shaft assembly comprising: a casing having a shaft aperture; a rotary shaft protruding from the casing through the shaft aperture; and a seal assembly extending between the casing and the shaft at the shaft aperture, the seal assembly defining an electrically conductive path between the engine casing and the shaft.

In still a further aspect, there is provided a method for dissipating electrical charge in an aircraft engine, the method comprising the steps of: establishing an electrically insulating path between an engine casing and a rotary shaft; establishing an electrically conductive path between the engine casing and the shaft via a seal assembly extending between the engine casing and the shaft; and dissipating accumulated electrical charge on the shaft via the electrically conducive path.

### DESCRIPTION OF THE DRAWINGS

Reference is now made to the accompanying figures in which:

FIG. 1 is a schematic cross-sectional view of an example aircraft engine.

FIG. 2 is a schematic cross-sectional view of a seal assembly of the aircraft engine of FIG. 1.

### DETAILED DESCRIPTION

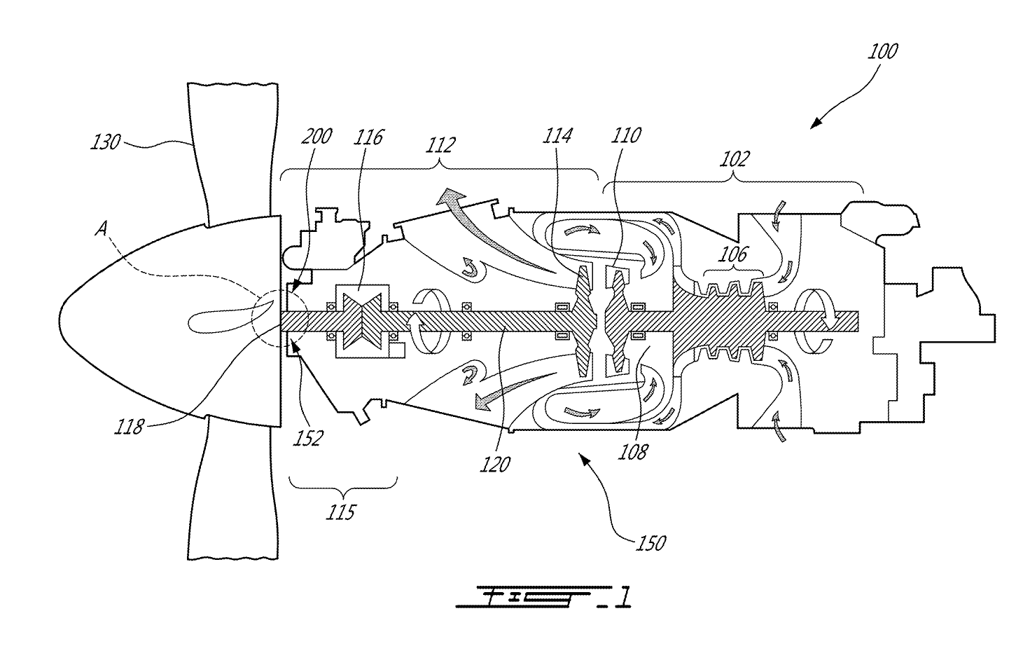

FIG. 1 illustrated an aircraft engine 100, for example of a type preferably provided for use in subsonic flight. In the example shown, turbine engine 100 is a turboprop gas turbine engine suitable for use in providing primary flight power for an aircraft. In the example, engine 100 comprises an engine core 102 and a power module 112. The engine core 102 includes an accessory gearbox (not shown), a multi-stage compressor 106, a combustor 108 (which is of the reverse-flow type in this example), and a high-pressure compressor turbine 110. In the example shown, power module 112 comprises power turbine 114 (which may be multi-stage) and rotor 115, which includes an output shaft 118 and a reduction gearbox (RGB) 116 for stepping down the rotational speed of turbine shaft 120 to a speed appropriate for driving the output shaft 118. The engine core 102 and the power module 112 are at least partially contained within an engine casing 150, which has a shaft aperture 152 through which the rotor 115, and more specifically the output shaft 118, at least partially protrudes.

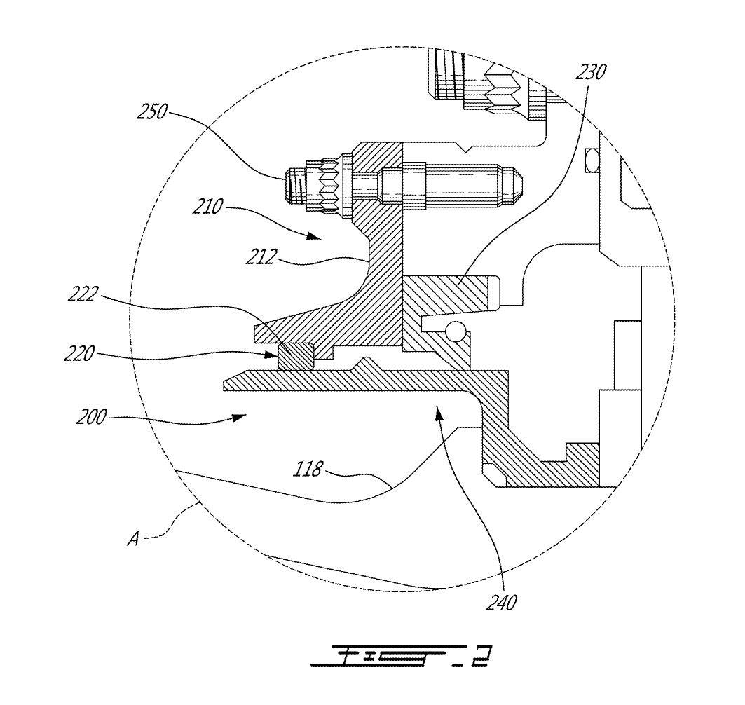

In a gas turbine engine such as a turboprop engine 100, power is provided to a propeller 130 via the rotor 115, and more specifically by the RGB 116 which is connected to the output shaft 118, which in turn is mechanically coupled to the propeller 130. The output shaft 118 has a first portion which is inside the engine casing 150, and a second portion which protrudes outside the engine casing 150 via the shaft aperture 152. A seal assembly 200, better seen in FIG. 2, extends between the output shaft 118 and the engine casing 150 at the shaft aperture 152. In this embodiment, the seal assembly 200 extends vertically between the output shaft 118 and the engine casing 150. As discussed in greater detail hereinbelow, the seal assembly 200 can extend between the output shaft 118 and the engine casing 150 in any suitable orientation and direction, such as obliquely or horizontally for instance.

Rotation of the output shaft 118 is facilitated by one or more bearing assemblies (not illustrated), which can be disposed within the RGB 116 or at any other suitable location. The bearing assemblies are electrically isolating during operation due to an oil film which is present at the bearing assemblies where they rotate. As the output shaft 118 rotates, electrical charge generates on the output shaft 118. For example, the output shaft 118 can be struck by lightning or other electrical discharges, or can be subjected to triboelectric charge accumulation. Because of the electrically isolating nature of the bearing assemblies, the output shaft 118 can accumulate an electric potential difference vis-à-vis the engine casing 150. If the electric potential reaches or surpasses the breakdown threshold of the oil film in the bearing assemblies, the accumulated charge can dissipate via dielectric breakdown in the bearing assemblies. This can cause electrical discharge damage (EDD) to the bearing assemblies.

At the shaft aperture 152 of the engine casing 150, the engine casing 150 can come as close as possible to the output shaft 118. However, the rotating and non-rotating components can be subject to shocks, vibrations, and thermal growth during use, and bringing the non-rotating engine casing 150 too close to the rotating components could lead to contact therebetween, which could cause wear. This is often addressed in turboprop engines by use of a seal assembly 200 in which a seal bridges the remaining gap between the rotary and non-rotary components at the shaft aperture 152. The seal assembly 200 can be used to impede leakage from engine core fluids such as bearing oil to the environment, and/or to impede intrusion of external particles into the core engine, for instance. The seal assembly 200 can also include wear components, or components which are less expensive to replace than engine casing 150 itself and which can fail instead of the engine casing 150 in extreme circumstances.

With reference to FIG. 2, an example seal assembly 200 is shown. In this embodiment, the output shaft 118 includes a runner 260. The runner 260 is a wear component which is configured to be relatively easy to replace should wear exceed a predetermined threshold. The seal assembly 200 includes a seal 230 which is mounted to the engine casing 150 (typically indirectly) and engages the runner 260. Both the seal 230 and the runner 260 are annular components. Moreover, in this embodiment, the seal assembly further includes a dust shield 222 which also engages the output shaft 118 (more specifically the runner 260 in this embodiment), externally to the seal 230 relative the engine core. The dust shield can be used to protect the seal 230 from external intrusion of dust or the like during operation of the engine 100. The dust shield 222 is optional, and some aircraft engines omit this component entirely. Dust shields like the dust shield 222 are typically used in large turboprop engines.

As described hereinabove, the seal assembly 200 bridges the gap between the rotary and non-rotary components at the shaft aperture 152. The seal 230 can be positioned between the engine casing 150 and the output shaft 118, and the dust shield 222 can be received by the engine casing 150. In the embodiment of FIG. 2, the seal assembly 200 has an annular receiver 210 in the form of an annular groove which serves as a structure for receiving the dust shield 222. For example, the annular receiver 210 can form part of an annular structure which is fixed to the engine casing 150 via any appropriate fastener such as threaded fasteners 250.

More specifically, in the embodiment of FIG. 2 the seal assembly 200 includes a seal 230. The seal 230 is also an annular component in this embodiment and is typically made of a resilient, elastomeric material. In some embodiments, the seal 230 is made of an elastomeric material selected to withstand the pressures and temperatures in the apparatus, and which is resistant to the nature of ambient fluids in the engine casing 150, for example oil. Alternatively, or in addition, the annular receiver 210 of the seal assembly 200 provides a channel 220 which accommodates the dust shield 222, which serves to block debris or solids from penetrating the space between the shaft 118 and the seal 230. For example, the dust shield 222 is a felt strip or other textile material.

In certain embodiments, the output shaft 118 has a runner 260 which coaxially surrounds the shaft and which has a face that extends radially with respect to a rotation axis of the output shaft 118. The elastomeric seal 230 can be engaged with the runner 260. Similarly, the dust shield 222 can be engaged with the runner 260. In various embodiments, the runner 260, or another suitable portion of the output shaft 118 can be provided in a manner for the dust shield 222 to extend or contact vertically, axially, radially, or obliquely (e.g. 45°). In certain other embodiments, the seal 230 and the dust shield 222 can be configured to engage different portions of the rotor.

In order to facilitate or provide for dissipation of the accumulated charge on the output shaft 118, the dust shield 222 and/or the elastomeric seal 230 can be made to conduct electric charge from the output shaft to the engine casing 150 without passing through the bearing assemblies of the RGB 116 and/or of other components of the rotor 115. Thus, an electrically conductive path can be defined across the dust shield 222, across the elastomeric seal 230, or both, between the engine casing 150 and the output shaft 118.

In some embodiments, the elastomeric seal 230 can be conductive. This can be achieved by using an elastomeric seal 230 which is made of a conductive elastomeric material, or by using an elastomeric seal 230 which is covered by a conductive coating. Some conductive elastomeric materials are available on the market, and can consist of a blend of rubber or plastic with conductive particles for instance (e.g. rubber or polytetrafluoroethylene (PTFE) doped with conductive particles for conductivity, for example carbon). Some example brand name conductive elastomeric materials include TURCON® and RADIAMATIC®. Alternately, the elastomeric seal 230 can be made of a non-conductive elastomeric material covered by a conductive coating of carbon, silver, or any other suitable material or combination of materials. Still other embodiments of the elastomeric seal 230 are considered, for example an elastomeric seal 230 made of a conductive material and covered with a conductive coating.

In some other embodiments, the dust shield 222 can be made of a conductive felt, or any other suitably conductive material which can serve to block debris or solids. For example, the dust shield 222 can be made of a textile material having fibers impregnated with a conductive media like carbon dust, or having fibers impregnated or coated with a semiconducting media like silicon. In another example, the dust shield 222 can be made of a textile material having fibers impregnated with a non-metallic solid material that becomes conductive when exposed to friction and/or when exposed to a magnetic field. In a further example, the dust shield 222 can be made of a blend textile material having conductive fibers, of a blend of non-conductive textile material and threads of conductive material, or of a textile material having hollow fibers or tubules charged with a low-ionization-threshold gas to render conductive when exposed to an electric potential. The dust shield can have fibers blended with a conductive media in the form of threads, like sliver threads. Still other types of conductive dust shields 222 are considered.

Alternatively still, both the dust shield 222 and the elastomeric seal 230 are conductive. Either or both of the conductive dust shield 222 and the conductive elastomeric seal 230 provide an electrically conductive pathway through which electric charge accumulated on the output shaft 118 can dissipate. When electric charge begins to accumulate on the output shaft 118, it can dissipate to the engine casing 150 via the conductive dust shield 222 and/or the conductive elastomeric seal 230. In particular, the electric charge dissipates through the conductive dust shield 222 and/or the conductive elastomeric seal 230 instead of one of the bearing assemblies because the conductivity of the conductive dust shield 222 and/or the conductive elastomeric seal 230 is greater than that of the bearing assemblies. This can help prevent accumulation of any significant level of electric charge and reduce the risk of EDD to the bearing assemblies in the RGB 116.

In certain embodiments, both the dust shield 222 and the elastomeric seal 230 are conductive, providing a plurality of electrically conductive paths through which electric charge accumulated on the output shaft 118 can dissipate to the engine casing 150. In certain embodiments, the dust shield 222 and/or the elastomeric seal 230 have galvanic potentials that are substantially similar to the galvanic potential of the output shaft 118 and/or of the engine casing 150. This may facilitate the discharge of electric charge from the output shaft 118 to the engine casing 150.

The electrically conductive path can also be defined by ensuring that the seal 130 and/or the dust shield 222 are electrically connected to both the engine casing 150 and the output shaft 118. For instance, a portion of the output shaft 118 with which the dust shield 222 and/or seal 230 is engaged can be unpainted, painted with a conductive paint, or covered with a protective, electrically conductive metal such as chromium for instance. Similarly, the dust shield 222 and/or the seal 230 can be adhered to the engine casing 150 using an electrically conductive adhesive. In another example, a portion of the engine casing 150 with which the dust shield 222 and/or the seal 230 is in contact with can be unpainted, painted with a conductive paint, or treated with an electrically conductive coating such as Alodine®.

For example, the dust shield 222 can be made of silver coated wool, i.e. wool fibers covered by silver, or the elastomeric seal 230 can have a silver coating, in a context where silver has a galvanic potential substantially similar to chromium used to cover the corresponding portions of the output shaft, for instance. In still further embodiments, the output shaft 118 is coated with a material to facilitate the discharge of electric charge therefrom, for example a material having a galvanic potential similar to that of the conductive dust shield 222 and/or the conductive elastomeric seal 230.

Although the embodiments described hereinabove pertain primarily to turboprop engines, the seal assembly 200 can alternately be used on turboshaft engines, as well as on other types of aircraft engines such as APU's for instance, or any engine that powers an aircraft propulsion system or auxiliary power unit, including electric engines or otherwise turbineless engines for instance. Generally, a seal assembly having an electrically conductive path can be applied to shaft assemblies having a casing and a rotary shaft and having a seal assembly to close the gap between these two, and using this seal assembly as the conductive path. Such a shaft assembly having an electrically conductive path can also be applied to other types of machines, such as a windmill for instance. Indeed, the solution may be retro-fittable to a windmill or to an aircraft engine, or included as part of the initial construction or device.

Additionally, the seal assembly 200 can be used with other types of aircraft: for example, the seal assembly can be used for an output shaft or other output component of a rotorcraft. Moreover, although the foregoing discussion focused mainly on aircraft-related embodiments, the seal assembly 200 can be used in non-aircraft settings to dissipate accumulated electrical charge from a rotating shaft toward a casing from which the shaft protrudes. Thus, for example, the seal assembly can be used in wind turbines or other windmill-like turbines, used for the generation of electricity, or in other electricity-generation settings. Still other applications of the seal assembly 200 are considered.

In particular, dissipating the electrical potential buildup in a rotor can be particularly useful in the context of a stealth aircraft, in which electrical arcing can produce broadband radio emissions, or detectable visible or infrared light, which may be detectable, thereby impeding the stealth properties of the stealth aircraft. The casing seal 200 can be placed around a rotatable shaft in a stealth aircraft to dissipate electrical charge accumulated thereon, thereby reducing or eliminating the potential for electrical arcing. In turn, the reduction or elimination of electrical arcing can help maintain the stealth properties of the stealth aircraft.

The above description is meant to be exemplary only, and one skilled in the art will recognize that changes may be made to the embodiments described without departing from the scope of the invention disclosed. For example, other types of aircraft engines than turboprop turbine engines can benefit from using an electrically conductive seal assembly. For example, different materials, coatings, blends, and the like may be used to render the dust shield and/or the elastomeric seal conductive. An embodiment can have only the dust shield forming the conductive path itself, with the seal being non-conductive. Hence the conductive path would include a conductive dust shield being engaged with an electrically conductive surface of the output shaft and an electrically conductive surface of the engine casing. Still other modifications which fall within the scope of the present invention will be apparent to those skilled in the art, in light of a review of this disclosure, and such modifications are intended to fall within the appended claims.

1. An aircraft engine comprising:
an engine casing housing the engine, the engine casing having a shaft aperture;
a shaft rotatably mounted to the engine casing, the shaft protruding from the engine casing through the shaft aperture; and
a seal assembly extending between the engine casing and the shaft adjacent the shaft aperture, the seal assembly defining an electrically conductive path between the engine casing and the shaft.

2. The aircraft engine of claim 1 wherein the electrically conductive path includes an electrically conductive seal engaged with an electrically conductive surface of the shaft.

3. The aircraft engine of claim 2 wherein the electrically conductive seal is made of an electrically conductive elastomeric material.

4. The aircraft engine of claim 2 wherein the electrically conductive seal is made of an elastomeric material covered by a conductive coating.

5. The aircraft engine of claim 1 further comprising a propeller mounted to the shaft externally to the engine casing, an electrically conductive dust shield being engaged with an electrically conductive surface of the shaft, and a seal recessed within the engine casing relative to the dust shield, wherein the electrically conductive path includes the electrically conductive dust shield.

6. The aircraft engine of claim 5 wherein the dust shield is made of a felt material having fibers covered by conductive particles, the dust shield being adhered to the engine casing via a conductive adhesive.

7. The aircraft engine of claim 5, wherein the dust shield is made of a felt material having fibers covered by semi-conductive material.

8. The aircraft engine of claim 5, wherein the dust shield is made of a felt material having at least one of hollow fibers and tubules charged with a low-ionization-threshold gas.

9. A shaft assembly comprising:
a casing having a shaft aperture;
a rotary shaft protruding from the casing through the shaft aperture; and
a seal assembly extending between the casing and the shaft at the shaft aperture, the seal assembly defining an electrically conductive path between the engine casing and the shaft.

10. The shaft assembly of claim 9 wherein the electrically conductive path includes an electrically conductive seal engaged with an electrically conductive surface of the shaft.

11. The shaft assembly of claim 10 wherein the electrically conductive seal is made of an electrically conductive elastomeric material.

12. The shaft assembly of claim 10 wherein the electrically conductive seal is made of an elastomeric material covered by a conductive coating.

13. The shaft assembly of claim 9 further comprising an electrically conductive dust shield being engaged with an electrically conductive surface of the shaft and a seal recessed within the engine casing relative to the dust shield, wherein the electrically conductive path includes an electrically conductive dust shield.

14. The shaft assembly of claim 13 wherein the dust shield is made of a felt material having fibers covered by conductive particles, the dust shield being adhered to the engine casing via a conductive adhesive.

15. The assembly of claim 13, wherein the dust shield is made of a felt material having fibers covered by semi-conductive material.

16. The assembly of claim 13, wherein the dust shield is made of a felt material having at least one of hollow fibers and tubules charged with a low-ionization-threshold gas.

17. A method for dissipating electrical charge in an aircraft engine, the method comprising the steps of:
establishing an electrically insulating path between an engine casing and a rotary shaft;
establishing an electrically conductive path between the engine casing and the shaft via a seal assembly extending between the engine casing and the shaft; and
dissipating accumulated electrical charge on the shaft via the electrically conducive path.

18. The method of claim 17 wherein establishing an electrically conductive path between the engine casing and the shaft via a seal assembly comprises establishing an electrically conductive path via an electrically conductive seal engaged with an electrically conductive surface of the shaft.

19. The method of claim 18, wherein the electrically conductive seal is made of an electrically conductive elastomeric material.

20. The method of claim 17, wherein establishing an electrically conductive path between the engine casing and the shaft via a seal assembly comprises establishing an electrically conductive path via an electrically conductive dust shield engaged with an electrically conductive surface of the shaft, and wherein establishing an electrically insulating path between an engine casing and a shaft comprises establishing an electrically insulating path via a seal recessed within the engine casing relative to the dust shield.
